(19) United States
(12) Patent Application Publication
(10) Pub. No.: US 2016/0024803 A1
(43) Pub. Date: Jan. 28, 2016

(54) A WATERPROOF DECK FLOORING SYSTEM WITHOUT CAULKING

(71) Applicant: Costa G. CHITOURAS, Somerville, MA (US)

(72) Inventor: Costa G. Chitouras, Somerville, MA (US)

(21) Appl. No.: 14/774,588

(22) PCT Filed: Mar. 4, 2014
(86) PCT No.: PCT/US14/20162

§ 371 Date: Sep. 10, 2015

Related U.S. Application Data
(60) Provisional application No. 61/789,187, filed on Mar. 15, 2013.

(51) Int. Cl. E04F 15/02; B32B 27/36; B32B 7/12; B32B 9/02; E04B 1/66; B32B 3/10

(52) U.S. Cl. CPC E04F 15/02188; E04F 15/02183; E04F 15/02155; E04B 1/665; B32B 3/10; B32B 7/12; B32B 9/02; B32B 27/36; B32B 2307/7265; B32B 2471/00

(57) ABSTRACT

Disclosed herein is a waterproof, easy-to-install, easy to remove, easy to repair or replace, recyclable, flooring system. A substrate supports the floor, and planks are adhered to the substrate by a film sandwich, which can have an impermeable film and adhesive on both sides. The adhesive can be a pressure sensitive adhesive. This film sandwich can have the same width as the planks, or can be wider than the planks. The edges of two adjacent planks can share the same film sandwich strip so as to provide the longest adhered path for any water entering the slit formed by adjoining planks and exiting at the edge of any film-sandwich. Each side of the film sandwich may be coated with adhesives having different adhesive characteristics, i.e., different cohesive and adhesive strengths between the substrate and film and/or between the planks and the film.

### RELATED APPLICATIONS

This application claims the benefit of U.S. Provisional Application No. 61/789,187, filed on Mar. 15, 2013. The entire teachings of the above applications are incorporated herein by reference.

### BACKGROUND OF THE INVENTION

Inasmuch as waterproof, marine duty flooring systems are utilized under some of the most severe environmental conditions, such as rain, sunlight and temperature extremes, most of the background of this invention will discuss flooring systems that are designed primarily as marine flooring. Naturally, any extreme-duty-use-flooring can almost always be used in less demanding applications, including commercial and residential uses. For the purpose of reasonable brevity and clarity, discussions and descriptions of this invention will emphasize marine applications but are applicable to other uses.

Typical marine deck coverings are wood plankings with paint or oil coatings. The seams between the planks can be waterproofed by inserting cotton or other similar textile products that are embedded with wax or other oil-based products. In some cases, the flooring system can be made from coated canvas. Even aircraft carriers, with their enormous deck areas and high impact loads, have used wood as a deck covering.

For a century or more, teak decks have been considered the epitome of an effective and aesthetically desirable decking for marine use. The main virtues of teak wood for marine decks, other than its aesthetic characteristics, include its non-slip characteristics under dry and wet conditions and its exceptional durability compared to other woods, even when left uncoated. Nowadays, teak decking has become extraordinarily expensive, and is primarily used on large, expensive yachts. Maintaining teak marine decks can require significant labor costs, even if only a few planks must be replaced and re-caulked or refurbished.

In the 1980s, cork planking and extruded plastic materials, such as polyvinyl chloride (PVC), were introduced to replace teak decking. To make the cork and PVC deck materials look more like teak, the products were cut and installed with similar dimensions as teak planks, typically approximately two inches wide and approximately eight feet long. This planking typically used half-lap joints (also referred to as rabbet joints) along the length of both sides of each plank to accept polyurethane or similar caulking products. Caulking material is required for teak decks, as well as the aforementioned cork and PVC decks, in order to make the flooring waterproof. Often nowadays, and to allow for easier installation, very accurate patterns of the deck area are supplied to factories that assemble wider sections of teak, cork, or PVC yacht decking. These sections include polyurethane caulk lines, which are not necessarily required for waterproofing since there are no joints or separations of the wide plank surface beneath those caulk lines, except where one multi-plank deck section joins the adjacent multi-plank section that ultimately constitutes the full deck structure matching the supplied pattern. Caulking at these half-lap joints requires sanding the hand laid caulk lines and a significant surrounding surface area to produce a consistent smoothness and color on the whole deck.

Consequently, fiberglass has largely replaced wood, steel, and aluminum as a construction material for yachts. However, fiberglass lacks the non-slip characteristics of teak. While this problem can be addressed by embossing walking surfaces, it is not as aesthetically pleasing and desirable by consumers. Attempts to duplicate the appearance and performance of teak decks using other materials have been developed and utilized with some success, but PVC in particular suffers from additional problems such as excessive weight, high surface temperatures under sunlight (impossible to walk on barefoot), as well as great difficulty in being refurbished to its original appearance because of the initial embossing or texturing.

A typical teak deck installation requires a solid underlying substrate onto which a teak plank can be both glued and screwed. Typically, the surface of the substrate is epoxy coated for waterproofing, sealing, leveling or fairing the top surface of the substrate foundation, a practiced that is commonly followed in the marine industry and high value commercial and home installations. Recessed screw heads are subsequently covered with wood plugs, which are glued and sanded flush with the planks. The seams are typically waterproofed with a caulking compound, which can be a polyurethane product. Waterproofing the seams requires significant time and effort, and requires taping the seam edges, caulking the seams, waiting a day or longer for the caulk to cure, and slitting and sanding the raised caulking material to the level of the planks and plugs. The finished teak deck is sometimes oiled to help retain its original color or enhance its durability. While teak lumber is expensive, the labor costs for installing teak can be five to ten times more costly than the teak lumber costs.

With the introduction of cork, PVC, and similar products as lower cost replacements for teak decks, some of the processes of countersinking screw-heads and gluing and sanding bungs, have been eliminated. However, the basic procedure of spreading an epoxy or urethane adhesive on the substrate, carefully laying and taping (or adding weights to the planks) to hold the positions of the planks, waiting overnight or even days for the adhesive to set, taping and caulking the seams, and cutting and sanding off the excess caulking material involves very significant labor costs. Thus, while the installed price of a cork or PVC floor is somewhat lower than an installed teak floor, it is still high enough that the majority of yacht owners choose a painted surface with non-slip particles spread onto the painted walking surfaces, over teak or teak look-a-likes.

Accordingly, there is a need for an improved waterproof deck flooring system that requires less manual labor to install. Furthermore, there is a need for an improved flooring system that is waterproof while providing the aesthetic characteristics associated with traditional teak decking.

### SUMMARY OF THE INVENTION

Disclosed herein is a waterproof, aesthetically pleasing, self-draining, easy to install, easy to remove, easy to repair or replace, recyclable, flooring system. The waterproof flooring includes a substrate for supporting the floor, one or more first impermeable films having a lower surface adhered to the upper surface of the substrate, and one or more first planks or tiles having a lower surface adhered to the upper surface of the first impermeable film. The impermeable film can be the same width as the plank, narrower than the plank, or wider than the plank. The adjacent impermeable films can overlap. A first impermeable film can be bent at its edge so as to adhere to at least a portion of a border of a plank. The plank can be cork, tile, or any other preferably flexible flooring material. One or more of the adhesives can be a pressure sensitive adhesive, and the first impermeable film can be a plastic layer, such as a polyester film. The top edges of the planks can have an edge radius of, e.g., approximately one-eighth of an inch. One or more second impermeable films can have a lower surface adhered to the upper surface of the first planks or tiles, and one or more second planks or tiles can have a lower surface adhered to the upper surface of the second impermeable film.

A method of installing a waterproof floor includes adhering a lower surface of one or more impermeable films to an upper surface of a substrate and adhering one or more first planks or tiles to the upper surface of the one or more first impermeable films. The first impermeable film can be the same width as the plank, narrower than the plank, or wider than the plank. The adjacent first impermeable films can overlap. A first impermeable film can be bent at its edge so as to adhere to at least a portion of the edge of one or more planks. The plank can be cork, tile, or any other preferably flexible flooring material. One or more of the adhesives can be a pressure sensitive adhesive, and the first impermeable film can be a plastic layer, such as a polyester film. The top edges of the planks can have an edge radius of, e.g., approximately one-eighth of an inch. The method can further include adhering a lower surface of one or more second impermeable films to the upper surface of the one or more first planks or tiles, and adhering one or more second planks or tiles to the upper surface of the one or more second impermeable films.

The waterproof flooring system disclosed herein provides numerous advantages compared to traditional deck or floor construction.

The flooring provides superior waterproofing because the film sandwich disrupts the flow of water between the edges of the planks to the substrate. The water leakage pathway of the waterproof floor is significantly longer than the water leakage pathway in a typical teak deck installation. For example, the water leakage pathway can be about 2.5 inches (63.5 mm) long, whereas the water leakage pathway of a traditional deck is about 0.5 inches (12.7 mm). Optionally, the water leakage pathways can be made many times longer by positioning the film sandwiches so that they overlap or by using wider film sandwiches.

Some embodiments provide channels for water to drain, thereby reducing or eliminating standing water on the deck. In contrast, traditional teak, cork, or PVC decks with caulked joints are inherently flat surfaces without any localized drainage means and permit the formation of standing water. In other words, a traditional caulked deck does not have grooves or other inherent means for draining water from its surface prior to the formation of standing water.

In certain embodiments, the invention provides a surface that is easier to walk on and reduces instances of tripping. All deck substrates have some imperfections that preclude a perfectly flat substrate or a perfectly curved or cambered deck. For example, planks made of any product have some tolerance specification to their thickness. Planks or tiles with varying thicknesses, even as small as twenty thousandths of an inch (a half of a millimeter) can cause some people to trip while walking. Instances of tripping, due to imperfections in the substrate, planks, or both, can be reduced by providing highly rounded edge shapes. For example, providing an ⅛th inch radius along both edges of a one-quarter inch thick plank can greatly minimize the propensity to trip due to height variations in the floor surface levels without requiring extreme leveling of the substrate surface or the floor after installation.

The flooring system provides several desirable aesthetic improvement. The flooring system permits the use of planks or tiles having various widths and/or composition, particularly when the planks are cork, while avoiding the necessity to caulk the floor, which previously has been a necessity for waterproofing the deck. Cork planks are more readily available in a variety of widths. For example, cork planks can be 1 inch (25.4 mm) wide, which is useful for highly curved sections of a deck, 2 inches (50.8 mm) wide, which is the typical width of teak deck planking, 4 inches (101.6 mm) wide, which seems to be the most attractive cork plank for mid-size yachts, or 6 or 8 inches (152.4 to 203.2 mm) wide, which is particularly attractive on larger yachts. Teak, for example, are not readily available in 6 to 8 inch width planks. While varying this range of plank widths, there is a significant change in design utilizing different edge radii for the different width planks, which affect the resultant aesthetic “shadow” lines without affecting the utility or performances of either the water drainage channels, or, through “correcting” dimensional tolerance imperfections in the substrate or the planks, retaining the safety of tripping on the floor without the necessity of surface leveling of the floor after installation.

The film sandwich of the flooring system is almost completely protected against the adverse effects of foot traffic and weather conditions, including heat and cold, UV radiation, rain, and wind, since it is adhered to the bottom of the planks. In contrast, the caulk of traditional flooring systems is exposed to both foot traffic and weather, which can and does cause separation and delamination of the caulk from the edges of planks.

The film sandwich of the flooring system is also more protected against the adverse effects of expansion and/or contraction of the substrate, film sandwich, or planks. Temperature and/or moisture can cause the layers to expand or contract according to their unique expansion coefficient. Since all of the layers are substantially parallel, each layer moves a comparable distance in approximately parallel planes. Any strain is mitigated by the large surface areas of the planks and the substrate held together by the film sandwich's two thin, flexible adhesive layers. Additionally, the flexible nature of the film sandwich tends to accommodate differential expansion of the substrate and planks without cracking.

The flooring system is easier to install than other waterproof flooring systems primarily because the individual plank seams do not have to be caulked and finished. Also, laying strips of the film sandwich onto a deck is easy, clean, repeatable, and without time constraints imposed by trowling liquid or time- and temperature-sensitive epoxy or urethane adhesives. While carpet or pre-coated pressure sensitive adhesive coated planks are similarly easy to install, they do not produce a waterproof marine floor without incorporating the teachings of this invention.

The flooring is easier to repair or replace because individual planks can be removed without the need to entirely replace the floor. Specifically, the adhesive strengths can be selected so that individual planks can be removed from the flooring without contaminating either the plank or the substrate. Thus the planks can be removed free of adhesive, thereby permitting the planks to be recycled. The absence of any residual film sandwich on the planks and/or substrate is accomplished by utilizing adhesives with greater adherence to the plastic film than to the plank and/or substrate. This removal and replacement process can be approximately an order of magnitude less expensive than replacing a teak plank with epoxy or polyurethane adhesives plus the required caulking.

The flooring is less expensive than traditional flooring systems due to reduced labor and materials costs. Even given similar costs for planking materials, the plastic film, even when coated on both sides, is about a third the cost of epoxy or polyurethane adhesives, with labor costs for applying the adhesives on a substrate far exceeding the cost of the film sandwich.

The flooring can be made from a sustainable and reusable products, such as cork planks or tiles, vinyl tiles, or wood. Additionally, the flooring method is not limited to marine use, and can be used as a floor in a variety of different locations. For example, the flooring materials are flexible enough to accommodate curvatures in the substrate without requiring significant machining, wood working, or mechanical fasteners. Additionally, the planks or tiles are more readily removed and either reused or recycled if they are flexible enough so that they do not crack or otherwise shatter during removal.

Additionally, the flooring system provides for some exceptional thermal and acoustic performance characteristics, especially when cork planks are utilized. A cork deck is both quiet when walked on and provides a pleasantly comfortable tactile experience when walking barefoot or shod, and provides a sensation of a nearly constant temperature, whether in a winter or summer environment. As a deck floor, it also provides excellent insulation for any quarters located below the cork floor deck.

### BRIEF DESCRIPTION OF THE DRAWINGS

FIG. 1 is a schematic illustration of a edge view of a waterproof flooring system without the use of any caulking.

FIG. 2 is schematic illustration of an edge view of the waterproof flooring system of FIG. 1 illustrating an exploded view of the waterproof flooring system.

FIG. 3 is a schematic illustration of an edge view of a traditional teak, cork, or PVC floor installation.

FIG. 4 is the schematic illustration of an edge view of the traditional, caulked teak, cork, or PVC floor installation of FIG. 3 illustrating an exploded view of the components.

FIG. 5 is a schematic illustration of an edge view of a waterproof flooring system having more than one plank.

### DETAILED DESCRIPTION OF THE INVENTION

A description of example embodiments of the invention follows.

The above features and other details of the method and apparatus of the invention will now be more particularly described with reference to the accompanying drawings and pointed out in the claims. The same number in different figures represents the same item. The drawings are not necessarily to scale, emphasis instead being placed upon illustrating embodiments of the present invention. It will be understood that the particular embodiments of the invention are shown by way of illustration and not as limitations of the invention. The principle features of this invention can be employed in various embodiments without departing from the scope of the invention.

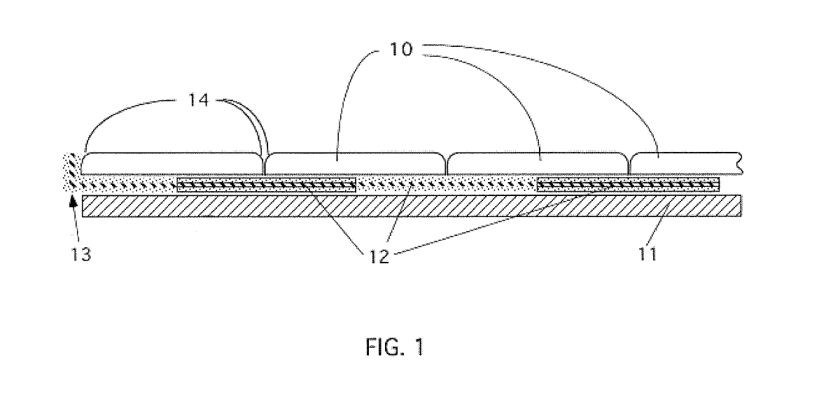

Referring now to FIG. 1, adjacent planks 10 are adhered to substrate 11 via film sandwiches 12 and 13. Film sandwiches 12 can have the same width as planks 10, except that a border or shaped plank section may require a wider, trimmed, and/or bent film sandwich 13. The vertical section of film-sandwich 13 can be adhered to the edge of plank 10, and/or to any sidewall or barrier (not shown) to provide a waterproof barrier adjacent to the laid plank floor. The film sandwiches 12 can also be narrower or wider than the planks 10.

The planks 10 can be made of a variety of materials suitable for marine decking, including teak, PVC, or cork. In a preferred embodiment, planks 10 can be made of cork. Typically, composite cork consists of mixed small cork granules with a binder (often referred to as adhesive or glue). The binder can be an aliphatic polyurethane, which is very stable under high UV conditions and readily bonds cork granules, often under some pressure and temperature. Other binders include a variety of rubber and chemical formulations, such as neoprene, nitrile, ethylene propylene diene monomer (EPDM), and phenol formaldehyde.

Composite cork offers advantages over teak, PVC, and other similar materials. For example, cork has the lowest density of the three materials. Additionally, a cork deck does not need to be as thick as a teak deck. For example, a traditional teak deck requires a three-quarter inch (19 mm) thick plank, while a cork plank can be one-quarter of an inch (6 mm) thick, especially if the cork deck is made waterproof with the teachings disclosed herein. Since the density of teak is about three and one half times greater than the density of cork and the thickness of a teak plank is about three times that of a cork plank, a teak deck weighs about ten-and-one-half times more than a cork deck over any given surface area. For typical 40 foot (12.2 meters) yachts, a teak deck could easily weigh 300 pounds (136 kg), which could be replaced by a cork deck weighing less than 30 pounds (13.6 kg). Similar to teak, composite cork planks provide a slip-resistant surface in both in wet and dry conditions. Additionally, composite cork is an exceptionally good thermal barrier. Composite cork decks do not feel hot or cold underfoot and provide significant thermal insulation from both warm and cold environments for quarters below a cork-decked roof. Suitable cork materials that have been used and/or tested as cork flooring planks include product numbers NC-710, P-46, NC-711, PE 1865/03 FH, NC-80, NRT94, 3D PVC, all from Amorim Cork Composites (Trevor, Wis. and Portugal).

Planks 10 can be cut in width to match typical teak deck planks. Teak planks are usually narrow, typically under two inches (50.8 mm), so that they can be more easily curved in yacht installations. Preferably, cork planks can range from 1 inch (25.4 mm) to eight inches (203.2 mm). More preferably, the planks can be four inches (101.6 mm) wide. In a preferred embodiment, the planks can be molded with a large edge radius 14, e.g., a one-eighth inch (3.175 mm) radius. In some embodiments, the planks can be 0.236 inches (6 mm) thick.

As shown in FIG. 1, the planks are mounted with the large edge radius 14 on the top or walking surface of the floor, and the adjacent edges of the planks 10 contact each other. As described below, no caulking or other fillings are required in order to waterproof the floor. Typically, the film sandwich 12 is at least as wide as the planks 10. Preferably, the film sandwich 12 can be wider than the planks 10. The width of the film sandwich 12 depends on the desired amount of overlap (if any), among the film sandwiches 12.

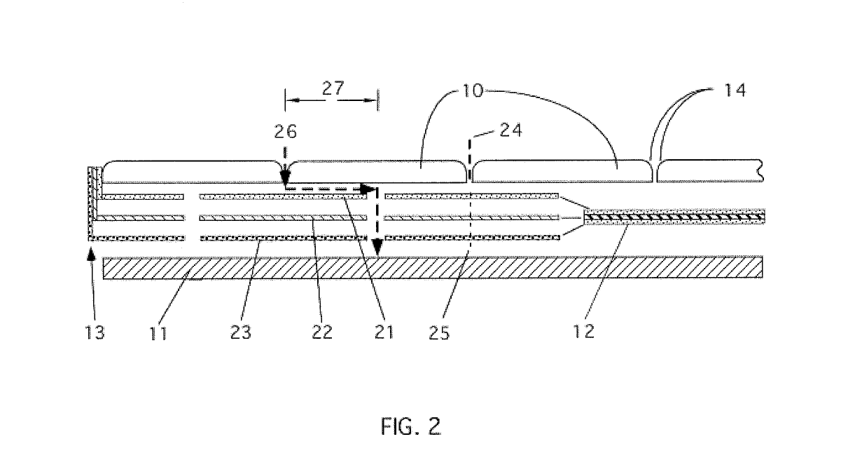

FIG. 2 is an exploded view of FIG. 1 that illustrates the film sandwich 12 in greater detail. The film sandwich includes a first adhesive 21 that is adhered to the upper surface of impermeable film 22 and a second adhesive 23 that is adhered to the lower surface of impermeable film 22. While FIG. 2 schematically illustrates the first adhesive 21, impermeable film 22, and second adhesive 23 as separate layers, the entire film sandwich can be manufactured and supplied as one piece, i.e., an impermeable film with both sides adhesive coated that constitutes the film sandwich 12.

In order to create a waterproof floor system, a joint line 24 is located between adjacent planks 10 at or near the centerline 25 of the film sandwich 12. The film sandwiches 12 can be laid down with edges just touching the adjacent film sandwiches 12 (i.e., side-by-side). This relative position of the planks 10 and film sandwich centerline 25 maximizes the length 27 of the film sandwich 12 from the edge of any plank 10 to either end. Consequently, any water entering a joint-line 24 between adjacent planks 10 (which in this example is 4 inches (101.6 mm) wide), must penetrate about two inches (50.8 mm) along the film substrate 21 before penetrating to the top of substrate 11. This length of water barrier is about five to ten times longer than a perfectly adhered caulked seam in a conventional teak deck installation, which will be illustrated below. To further maximize the bonded adhesive length 27, adjacent film sandwiches 12 may be laid down so that their edges overlap in order to effectively form a continuous layers of film sandwiches 12 and extend the continuous bonded length 27. The adjacent film sandwiches 12 may overlap by as much as 100%. With this construction technique, water entering joint-line(s) 24 cannot penetrate to reach substrate 11, except at the exterior limits of the deck.

Preferably, the film sandwich 12 is wider than the planks 10 and overlaps the edges of one or more adjacent film sandwiches 12 in order to provide a continuous water barrier without any slits, cracks, or other openings, unless the film sandwiches 12 are physically penetrated. Consequently, the water path 26 changes from about half the width of a single plank 10, which can be about two inches (50.8 mm), to about half the width of the whole floor installation, which can be many feet (or meters). Additionally, a second (or more layers) of the film sandwich 12 can be applied, in which case one layer of adhesive (either 21 or 23) on the additional film sandwiches can be eliminated, inasmuch as adhesive is already available from the first film sandwich 12 to adhere to the one side of the second film sandwich 12.

The film sandwich 12 is composed of a waterproof strip of flexible impermeable film 22. The impermeable film 22 can be a layer that prevents a liquid, usually water, from passing through it. While it is preferable that the impermeable film 22 completely prevents the passage of water, it is sufficient if the impermeable film 22 reduces the flow of water. It is also sufficient if the impermeable film 22 reduces the flow of water in only one direction. The impermeable film 22 is coated on both sides with adhesive 21 and 23. Preferably, first and second adhesives 21 and 23 can be a pressure sensitive adhesive. The impermeable film 22 can be a plastic film, such as a polyester film. The impermeable film 22 can typically be, e.g., from one-half-a-thousandth to six thousandths of an inch (0.0127 to 0.152 mm) thick. The first and second adhesives 21 and 23 can be the same adhesive, or they can be different adhesives. For example, the adhesives can provide differential bonding characteristics to the plank 10, impermeable film 22, and/or substrate 11. The first and second adhesives 21 and 23 can have a thickness similar to the range of a typical film thickness. In contrast to water or solvent activated adhesives or contact adhesives, a pressure sensitive adhesive can reduce labor costs. Additionally, a pressure sensitive adhesive permits repeatability in the performance of the adhesive-bonded surfaces by minimizing or eliminating human errors during adhesive applications. Exemplary film sandwiches that have been used experimentally are double sided, pressure sensitive adhesive tapes numbers 654M-74-54 and 1711-80-54, both manufactured by Adchem Corporation (Riverhead, N.Y.). One of skill in the art will recognize that while FIG. 2 illustrates a single impermeable film 22 having adhesive 21 and 23 on both sides, one can use two or more layers of film sandwiches 12, in which case only one film sandwich layer 12 requires two layers of adhesives 21 and 23. In other words, subsequent impermeable layers 22 can require only a single adhesive layer to adhere the multiple impermeable layers 22. Naturally, one may still use a film sandwich 12 having two adhesive layers 21 and 23 for all the layers of film sandwiches 12 required.

With the large number of pressure sensitive adhesive formulae available, one of skill in the art can coat the film sandwich 12 with adhesives that have a strong adhesion to the impermeable layer of the film sandwich and a lesser degree of adhesion to the plank 10 or the substrate 11. This allows the removal of the plank 10 from the film sandwich 12 and the removal of the film sandwich 12 from the substrate 11 to recycle the planks 10. The fact that the pressure sensitive adhesive 21 and 23 exhibit this temporary tack does not mean that the planks 10 do not adhere to the substrate well. The planks 10 can be adhered to the substrate 11 with assurance that under normal circumstances, even under marine uses, the planks will not readily separate from the substrate. But when the time comes to remove the planks for repair or recycling, a strong tug or two will cause the delamination of the plank 10 from the film sandwich 12.

Preferably, the second adhesive 23 that contacts the substrate 11 has a pull strength that is less than the pull strength of its adherence to the impermeable film 22. Likewise, the first adhesive 21 that adheres the impermeable film 22 to the flooring planks 10 can have an adhesive strength to the floor planks 10 that is less than the adhesive strength to the impermeable film 22. Providing different adhesive strengths relative to each of the four contact surfaces provides various benefits alluded to previously. For example, a plank 10 can be lifted or pulled up for repair or proper disposal without contaminating the plank with adhesive, thereby permitting reuse or disposal. Additionally, the film sandwich 12 can be lifted or pulled up for disposal, thereby leaving a clean substrate 11 to which new replacement planks 10 can be adhered. Individual planks 10 can be replaced or repaired as necessary without requiring removal and repair of the entire floor. Thus the floor can be recycled by literally lifting it up, which is far easier and much lower in cost than removing a typical marine deck, whether constructed of teak, cork, or plastic tiles.

When the substrate 11 is substantially flat, the planks 10 can be any planks that can adhere to a substrate without mechanical fasteners. For example, the planks 10 can be made of any flexible flooring planks, such as cork, PVC, or tile. Preferably, the planks 10 are made of cork, which is a sustainable product that, if properly removed from a prior installation, can be reused. Cork planks in particular have extraordinary thermal and acoustic properties, providing any living quarters located below a cork deck serving as a ceiling component, as is typical in yachts, with excellent warm or cool quarters appropriate to the weather. Additionally, walking on cork floors minimizes sound transmitted through a ceiling or generated within a room with cork floors.

To install the flooring, a lower surface of the film sandwich 12 is adhered to the upper surface of substrate 11. Typically, a second film sandwich 12 is laid down parallel to the first film sandwich 12. The second film sandwich 12 can be directly adjacent to the first film sandwich 12, or the two film sandwiches can overlap, or there can be a space separating the two film sandwiches 12. Next, a first plank 10 is adhered to the upper surface of the film sandwich 12 so that its centerline coincides (approximately) with the edge seams of the two film sandwiches 12. In other words, the plank 10 straddles the seam. When the adhesives 21 and 23 are pressure sensitive adhesives, pressure is applied to secure together the planks 10, film sandwiches 12, and substrate 10. Subsequently, an additional film sandwich 12 is applied in close proximity to (or even overlapping with) the seam of one of the previously laid film sandwiches 12. Another plank 10 is adhered, and the process is repeated until the floor is complete.

Construction usually begins in the middle of the floor and proceeds outwards, as is done in starting a common floor installation for a balanced plank or tile layout. Prior to installation, the substrate is optionally coated with a prime coat or a fairing coat of epoxy. The substrate 11 can be wood, fiberglass, aluminum or steel, but any clean substrate to which the film sandwich adheres is acceptable. One of skill in the art will recognize that variations in this order may at times be desirable or necessary to facilitate other objectives or requirements of a marine or other deck or floor.

Since the planks 10 are placed one-at-a-time onto the film sandwiches 12, the film sandwiches 12 can also be laid one-by-one, except for the first lay down when two or three film sandwiches 12 may be advantageously positioned in place. Thus the planks 10 can then be put in place with a light touch and the first plank 10 can be accurately aligned. When necessary, one may lift and reposition the plank 10 if it was not precisely placed. This lift-and-reset can readily be done for some time provided the plank has not been heavily pressed down onto the pressure sensitive adhesive. Furthermore, when finally positioned, the pressure sensitive adhesive adhered plank cannot readily move or slide out of position as is common with liquid epoxy or urethane adhesives.

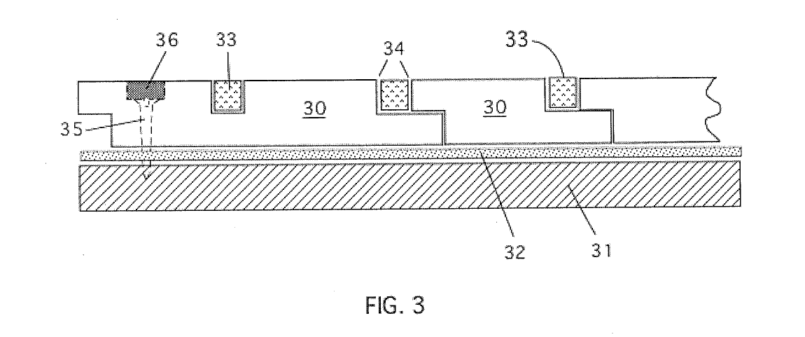

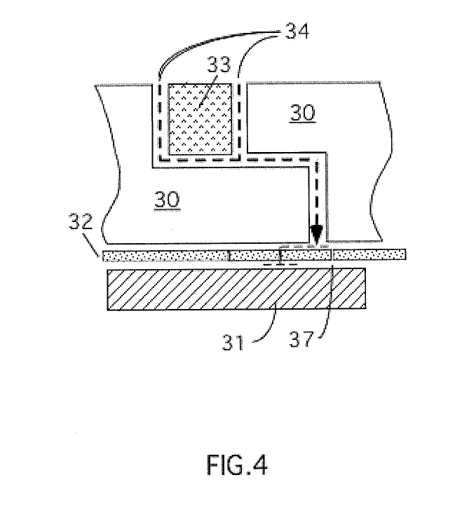

FIGS. 3 and 4 are schematic representations of a traditional, prior art method of waterproofing a deck with the use of caulk. Adjacent planks 30, which are typically teak but can be cork or PVC, are adhered to substrate 31 via adhesive 32. Adhesive 32 is typically a two-part epoxy or polyurethane liquid adhesive that is troweled wet onto substrate 31. Adhesive 32 must be spread in a continuous layer under the planks 30 as the planks 30 are laid, and the planks 30 must be accurately set in their final positions before the adhesive 32 hardens. Consequently, the planks 30 must be laid quickly, and it can be difficult to remove an improperly laid plank 30.

Caulk 33 in FIG. 4 is the crucial element preventing water penetration between the top edges of the planks 30 through to adhesive 32 and ultimately to the bottom of plank 30 and/or substrate 31 through possible breaks through to adhesive 32. Thus, the caulk 33 must remain flexible and adhered to both the adjacent planks 30 in order for the seam to remain waterproof. The potential and commonly experienced water leakage pathways 34 are represented in the expanded drawing by dashed lines with an arrowhead. Screw 35 in FIG. 3 is used to mechanically fasten a teak plank 30 (and not cork or PVC planks), and is almost always countersunk with a countersunk hole plugged with a wooden bung 36.

In comparison to the planks 30 in FIG. 3 or FIG. 4, which represent typical teak planks used with caulking, the planks 10 in FIG. 1 and FIG. 2 have significant radii (or bevels) 14. The edge radii 14 on planks 10 can define channels on the surface of the floor to provide for the automatic draining of water from the deck surface in order to eliminate standing water or puddles. Additionally, the large edge radii 14 provide a means for minimizing the transition from the height of one plank 10 to a slightly different height of an adjacent plank 10. These height differences can be within the thickness tolerance of the planks 10 and/or be caused by variations in height of the surface structure of the substrate 11. The large edge radii 14 can generate boundary and shadow lines that are highly attractive, particularly in large expanses of flooring. The dimensions of the edge radii can be approximately one half the thickness of the plank 10.

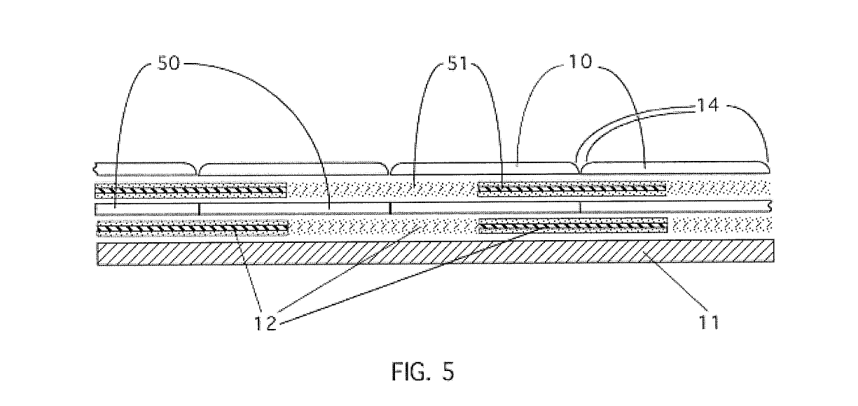

FIG. 5 is a schematic representation of another embodiment that is valuable for minimizing repair or replacement costs. For example, it can be desirable or necessary to change a flooring prior to its normal end-of-life. Owners of yachts, cruise ships, hotels, high end buildings, and even well kept commercial or private homes may wish to refurbish or replace a floor before the end-of-life requires such replacement. Not only can replacing the flooring be expensive, but it can cause inconveniences and require downtime in order to complete the work.

Referring to FIG. 5, planks 10 can be adhered to underplanks 50 via film sandwiches 51, which are substantially similar to film sandwiches 12. As illustrated in FIG. 5, the planks 10 may be thinner than the planks 10 of FIGS. 1 and 2. For example, planks 10 can be 0.118 inches (3 mm). Underplanks 50 can be made of any suitable material, including those materials suitable for planks 10. Preferably, underplanks 50 can be cork. The underplanks 50 do not requires edge radii 14, but it can be included if desired. Underplanks 50 are adhered to substrate 11 via film sandwiches 12. When film sandwiches 12 and film sandwiches 51 are each laid with overlapping edge joints, two impermeable waterproof layers are formed, one beneath the planks 10 and the other beneath underplanks 50.

The embodiment of FIG. 5 offers several additional advantages. When deciding to repair or replace the waterproof floor, one may remove some or all of the planks 10 (and film sandwich 51, if required) without compromising the integrity of the waterproof floor. By repairing or replace only planks 10 and not underplanks 50 (which literally have experienced no wear), the repair or replacement costs decrease since only half the cork cost is required. Testing has shown that cork wear is so small when foot traffic is involved that a one-eighth inch thick plank of wood, cork or PVC will easily survive foot traffic in the millions of foot traffic steps. Additionally, underplanks 50 can literally serve as a temporary floor with almost all the attributes of the original floor.

The embodiment of FIG. 5 can be installed similarly to the previously-described installation methods. After the film sandwich layer 12 has been laid on the substrate 11, the underplanks 50 are laid and secured to the film sandwich 12. Then, another film sandwich layer 51 is applied, and the surface planks 10 are laid and secured.

While this invention has been particularly shown and described with references to examples and embodiments thereof, it will be understood by those skilled in the art that various changes in form and details may be made therein without departing from the scope of the invention encompassed by the appended claims.

1. A waterproof flooring comprising:
a) a substrate for supporting the floor;
b) one or more first impermeable films having a lower surface adhered to the upper surface of the substrate; and
c) one or more first planks or tiles having a lower surface adhered to the upper surface of the first impermeable film, wherein the one or more first planks or tiles are formed of cork.

2. The waterproof flooring system of claim 1, wherein the first impermeable film is approximately the same width as the plank.

3. The waterproof flooring system of claim 1, wherein the first impermeable film is wider than the plank.

4. The waterproof flooring system of claim 1, wherein the first impermeable film is narrower than the plank.

5. The waterproof flooring system of claim 1, wherein adjacent first impermeable films overlap.

6. The waterproof flooring system of claim 1, further comprising a bent first impermeable film along at least a portion of a border of a plank.

7. (canceled)

8. The waterproof flooring system of claim 1, wherein one or more of the adhesives is a pressure sensitive adhesive.

9. The waterproof flooring system of claim 1, wherein the first impermeable film is a plastic layer.

10. The waterproof flooring system of claim 9, wherein the first impermeable film is a polyester film.

11. The waterproof flooring system of claim 1, wherein the one or more of first planks have an approximately one-eighth inch edge radius.

12. The waterproof flooring system of claim 1, further comprising:
a) one or more second impermeable films having a lower surface adhered to the upper surface of the first planks or tiles; and
b) one or more second planks or tiles having a lower surface adhered to the upper surface of the second impermeable films.

13. A method of installing a waterproof floor, comprising:
a) adhering a lower surface of one or more first impermeable films to an upper surface of a substrate;
b) adhering one or more first planks or tiles to the upper surface of the one or more first impermeable films, wherein the one or more first planks or tiles are formed of cork.

14. The method of claim 13, wherein the first impermeable film is the same width as the plank.

15. The method of claim 13, wherein the first impermeable film is wider than the plank.

16. The method of claim 13, wherein the first impermeable film is narrower than the plank.

17. The method of claim 13, wherein adjacent first impermeable films overlap.

18. The method of claim 13, further comprising a bent first impermeable film along at least a portion of a border of a plank.

19. (canceled)

20. The method of claim 13, wherein one or more of the adhesives is a pressure sensitive adhesive.

21. The method of claim 13, wherein the first impermeable film is a plastic layer.

22. The method of claim 21, wherein the first impermeable film is a polyester film.

23. The method of claim 13, wherein the one or more of first planks have an approximately one-eighth inch edge radius.

24. The method of claim 13, further comprising:
a) adhering a lower surface of one or more second impermeable films to the upper surface of the one or more first planks or tiles;
b) adhering one or more second planks or tiles to the upper surface of the one or more second impermeable films.

25. The waterproof flooring of claim 1, wherein the waterproof flooring is a marine deck.

26. The method of claim 13, wherein the waterproof floor is a marine deck.
